(19) United States
(12) Patent Application Publication
(10) Pub. No.: US 2018/0143889 A1
(43) Pub. Date: May 24, 2018

(54) METHOD AND DEVICE FOR PROVIDING A TEST RESPONSE

(71) Applicant: Robert Bosch GmbH, Stuttgart (DE)

(72) Inventor: Wilhelm Petkof, Wernau (DE)

(21) Appl. No.: 15/575,118

(22) PCT Filed: Mar. 2, 2016
(86) PCT No.: PCT/EP2016/054401

§ 371 Date: Nov. 17, 2017

(30) Foreign Application Priority Data
May 18, 2015 (DE) 10 2015 209 033.7

(51) Int. Cl. G06F 11/22; G06F 11/273

(52) U.S. Cl. CPC G06F 11/2242; G06F 11/3027; G06F 11/2733

(57) ABSTRACT

A method for providing a test response for testing a function of a master unit of a synchronous serial data bus, the method including a step of monitoring and a step of providing. In the step of monitoring, a command bit sequence on a command channel of the data bus is monitored in order to detect a predetermined command from the master unit. In the step of providing, the test response is provided on a response channel of the data bus in response to a detected predetermined command, a response bit sequence of the test response being provided by using a response rule predefined in a short-term memory.

### BACKGROUND INFORMATION

The present invention is relates to a device, a method, and a computer program for providing a test response.

On a data bus, it is possible to test a master unit of the data bus in that at least one slave unit controlled by the master unit provides a data value that is defined in the master unit as a threshold value. For this purpose, for example, it is possible that an external test apparatus provides the slave unit with a defined measured variable.

### SUMMARY

In accordance with the present invention, a method is provided for providing a test response for testing a function of a master unit of a synchronous serial data bus, a device that uses this method and a corresponding computer program. Advantageous developments and improvements of the device are described herein.

When a measured variable is mapped by a slave unit in a data value, it is possible that mapping errors falsify the data value. If the data value of the slave unit is manipulated as a digital value, then it is possible to test a threshold value to be tested in the master unit in bit-precise fashion since mapping errors in the slave unit play no role in a direct manipulation of the data value.

In accordance with the present invention, it is possible to test a function of a master unit on a data bus quickly, precisely and cost-effectively, it being possible to dispense with a cost-intensive test apparatus.

A method for providing a test response for testing a function of a master unit of a synchronous serial data bus is provided, the method including the following steps:

monitoring a command bit sequence on a command channel of the data bus in order to detect a predetermined command from the master unit; and providing the test response on a response channel of the data bus in response to a detected predetermined command, a response bit sequence of the test response being provided by using a response rule predefined in a short-term memory.

A master unit may be understood as a processing unit that is developed to control other processing units (such as for example a slave unit) or an algorithm being executed in these processing units, or provide these processing units with data. A function of a master unit may be understood as a software-controlled reaction to an item of information received by the master unit. A test response may be a predefined item of information for the master unit. A command bit sequence may be a bit sequence that represents a sequence of different commands on the command channel. A predetermined command may be a segment of the command bit sequence. A response bit sequence may be a bit sequence that represents the test response on the response channel. A response rule may be an operational instruction for generating the response bit sequence.

This method may be implemented for example in software or hardware or in a mixed form of software and hardware for example in a control unit.

The method may include a step of writing, in which another response rule is written into the short-term memory after the command is detected. The additional response rule maybe written by using a test rule. By directly reloading a new response rule, it is possible to react immediately to a subsequent detection of a predetermined command.

The test response may be furthermore provided on the response channel by using a response resulting from the command. The response is read in and may be changed in at least one bit of the response by using the response rule in order to obtain the test response. By changing a response in bit-wise fashion, it is possible to determine exactly which position of the response bit sequence of the test response is changed. It is thus possible for the test response to have a naturally occurring variance around the specified changed position.

In the step of monitoring, it is furthermore possible to monitor at least one address channel of the data bus. The command may be detected when on the address channel a predetermined slave unit is addressed that is connected to the data bus and is hierarchically subordinate to the master unit. By monitoring the address channel, it is possible to test a master unit of an extensive data bus. By monitoring the address channel, it is possible to prevent a response of an unintended slave unit from being changed.

The command bit sequence may be monitored by using a predefined command pattern in order to detect the command. A command pattern may comprise multiple bits. The command pattern may be characteristic for the command. The command pattern makes it possible to detect the command reliably.

In the step of monitoring, it is possible to monitor at least one predefined sub-range of the command bit sequence in order to detect the command. In particular, it is possible to monitor a first sub-range and at least a second sub-range of the command bit sequence in order to detect the command. It is possible for there to be a space of a width of at least one bit between the first sub-range and the second sub-range. The command may be characterized by a bit sequence that is situated at an arbitrary position of the command bit sequence. A defined monitoring range makes it possible to ignore irrelevant bits.

The test response furthermore may be provided in response to an enable signal. The enable signal may represent a fulfilled external condition. Thus, the master unit may be tested when the external condition is fulfilled.

The method may have a step of predefining, in which in response to a start signal the response rule is predefined in the short-term memory. In particular, the step of predefining may be carried out prior to the step of providing. A step of predefining makes it possible directly to detect the first command on the command channel and to provide a test response. The step of predefining makes it possible for the test to be performed quickly.

Furthermore, a device for providing a test response for testing a function of a master unit of a synchronous serial data bus is provided, the device having the following features:

a monitoring device, which is designed to monitor a command bit sequence on a command channel of the data bus in order to detect a predetermined command from the master unit; and

an output device, which is designed to provide a response bit sequence of a test response on a response channel of the data bus in response to a detected predetermined command by using a response rule predefined in a short-term memory, the output device being looped into the response channel.

This embodiment variant of the present invention in the form of a device also makes it possible to achieve the objective, on which the present invention is based, rapidly and efficiently.

In the present case, a device may be understood to refer to an electrical device which processes sensor signals and, as a function thereof, outputs control signals and/or data signals. The device may include an interface developed in the form of hardware and/or software. In a hardware implementation, the interfaces may be part of what is commonly known as a system ASIC, for instance, which encompasses a wide variety of functionalities of the device. However, it is also possible for the interfaces to be separate, integrated circuits or to be at least partially made up of discrete components. In a software development, the interfaces may be software modules which, for example, are present on a microcontroller in addition to other software modules.

Also advantageous is a computer program product or computer program having program code, which may be stored on a machine-readable carrier or storage medium such as a semiconductor memory, a hard disk memory or an optical memory and which is used to carry out, implement and/or control the steps of the method according to one of the above-described specific embodiments, in particular when the program product or program is executed on a computer or a device.

Exemplary embodiments of the present invention are illustrated in the figures and explained in greater detail below.

### BRIEF DESCRIPTION OF THE DRAWINGS

FIG. 1 shows a block diagram of a device for providing a test response according to one specific embodiment.

FIG. 2 shows a flow chart of a method for providing a test response according to one specific embodiment.

FIG. 3 shows a representation of a synchronous serial data bus having a device for providing a test response according to one specific embodiment.

FIG. 4 shows a representation of a device for providing a test response according to one specific embodiment.

### DETAILED DESCRIPTION OF EXAMPLE EMBODIMENTS

In the description herein of advantageous exemplary embodiments of the present invention, identical or similar reference symbols are used for elements shown in the various figures that act similarly, a repeated description of these elements being omitted.

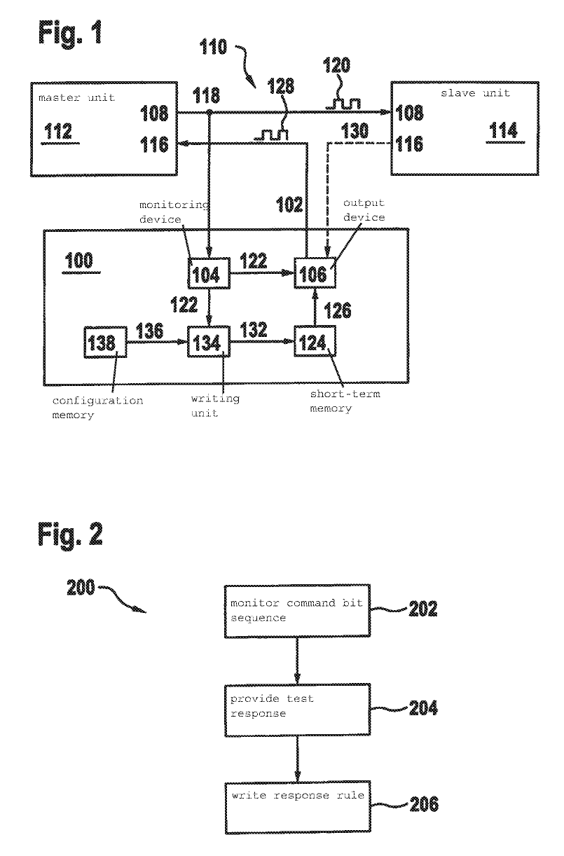

FIG. 1 shows a block diagram of a device 100 for providing a test response 102 according to one specific embodiment. Device 100 has a monitoring device 104 and an output device 106. Monitoring device 104 is connected to a command channel 108 of a synchronous serial data bus 110. Data bus 110 connects a master unit 112 and at least one slave unit 114 hierarchically subordinate to master unit 112. In addition to command channel 108, data bus 110 has at least one response channel 116. Master unit 112 transmits commands 118 to slave unit 114 via command channel 108. Slave unit 114 responds to commands 118 via the response channel 116. Monitoring device 104 is designed to monitor a command bit sequence 120 of commands 118 on command channel 108 in order to detect a predetermined command 118 from master unit 112. When detecting the command bit sequence 120 corresponding to command 118, an item of trigger information 122 is provided.

Output device 106 is looped into response channel 116 and is designed to provide the test response 102 on the response channel 116 of data bus 110 in response to trigger information 122. Test response 102 is provided by using a response rule 126 predefined in a short-term memory 124. Response rule 126 is read out in bit-wise fashion from short-term memory 124. Test response 102 has a response bit sequence 128. In particular, a length of response rule 126 corresponds to a length of the response bit sequence 128. The test response 102 is designed to test a function of the master unit 112.

A reaction of master unit 112 may be detected by monitoring channels 108, 116 of data bus 110. Slave unit 114 may be a sensor, for example. Test response 102 is then able to simulate a value measured by the sensor, even though the sensor currently does not measure this value at all. The simulated value may be smaller, for example, than a threshold value for triggering another command on command channel 108. In the normal function of master unit 112, the other command is not output. In a malfunction of master unit 112, the other command may be output in spite of the simulated value being too low, or a false command may be output. The simulated value may also be greater than the threshold value. Then master unit 112 outputs the other command when functioning properly. In the event of a malfunction of master unit 112, it is possible that no command is output, for example.

In one specific embodiment, test response 102 is provided by using a response 130 of slave unit 114 to command 118. For example, response rule 126 then defines in which positions a bit sequence of response 130 should be changed in order to obtain response bit sequence 128.

Master unit 112 may transmit the same command 118 periodically via data bus 110 to slave unit 114. Then it is possible to change the bit sequence of response 130 each time in a similar way by using response rule 126.

If test response 102 is to be changed, another response rule 132 is required. In one specific embodiment, device 100 has a unit 134 for writing to short-term memory 124. Unit 134 for writing is designed to write the further response rule 132 into short-term memory 124.

The writing may be performed in response to trigger information 122. Unit 134 for writing produces the additional response rule 132 by using a test rule 135. Test rule 136 is specifically adjusted to the command 118 that is to be tested. Test rule 136 is stored in a configuration memory 138 of device 100.

The writing may occur in bit-wise fashion. In the process, the first bit of the additional response rule 132 maybe written into short-term memory 124, while the first bit of response rule 126 is read out of short-term memory 124. In particular, the short-term memory 124 may be a register, which may be written to from an input side and which may be read out on an output side.

FIG. 2 shows a flow chart of a method 200 for providing a test response according to one specific embodiment. Method 200 may be carried out for example on a device such as is represented in FIG. 1. Method 200 has a step 202 of monitoring and a step 204 of providing. The test response is designed to test a function of a master unit of a synchronous serial data bus. For this purpose, in step 202 of monitoring, a command bit sequence is monitored on a command channel of the data bus in order to detect a predetermined command from the master unit. In response to the detection, the test response is provided, in step 204 of providing, on a response channel of the data bus. A response bit sequence of the test response is provided by using a response rule predefined in a short-term memory.

In one exemplary embodiment, method 200 has a step 206 of writing, in which a further response rule is written into the short-term memory, after the command is detected. The additional response rule is written by using a test rule.

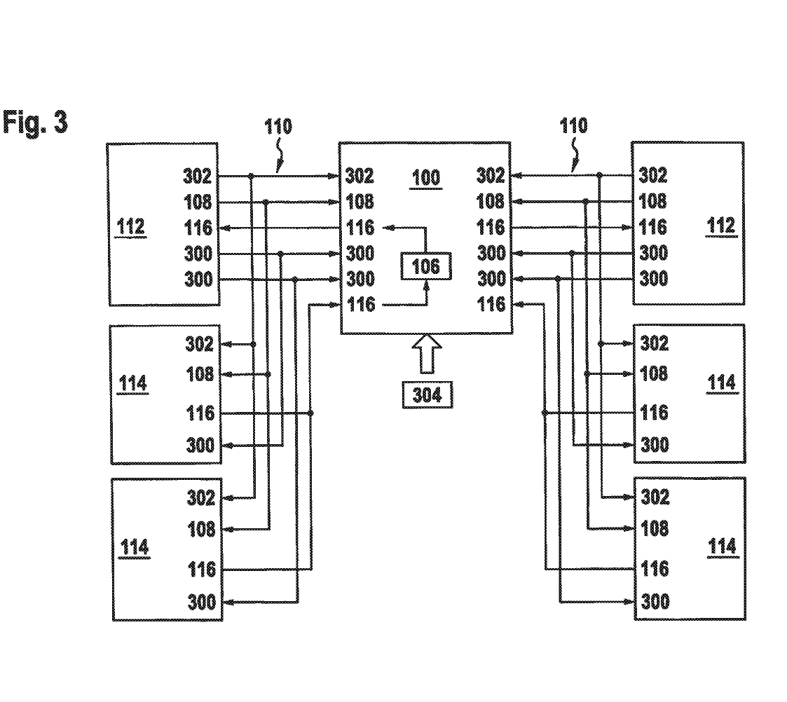

FIG. 3 shows a representation of a synchronous serial data bus 110 including a device 100 for providing a test response according to one specific embodiment. Device 100 essentially corresponds to a device as is represented in FIG. 1. In this instance, however, only output device 106 is represented. In addition, device 100 is connected, analogous to data bus 110, to at least one additional synchronous serial data bus 110, in order to provide in the additional data bus 110 likewise the test response for testing the additional master unit 112. In particular, it is possible to connect up to four data buses 110 to device 100.

In addition to the data bus in FIG. 1, at least one additional slave unit 114 is here connected to data bus 110. In order to be able to address slave units 114 individually, data bus 110 has an address channel 300. Thus it is possible to assign the command to a specific slave unit 114 even when the command bit sequence is identical. Address channel 300 is likewise monitored by device 100 in order to be able to provide the test response when a response is output by the specific slave unit 114.

Data bus 110 furthermore has a clock channel 302, via which the communication of all subscribers 112, 114 on data bus 110 is synchronized or clocked. Device 100 is likewise connected to clock channel 302 in order to be able to provide the test response in a synchronized or clocked fashion.

In order to test the command, device 100 is configured using configuration information 304. Configuration information 304 is stored in the configuration memory. Configuration information 304 represents a characteristic bit pattern or command pattern of the command that is to be tested. Configuration information 304 furthermore represents a bit mask in order to define which bits of the command bit sequence are to be tested. In one exemplary embodiment, the command is mapped partially in the bit pattern or the bit mask, in order to be able to test multiple similar commands.

The bit mask may also define multiple test windows distributed over a data word of the command bit sequence, the bits being tested in the test windows in order to detect the command. In other words, the bit mask defines at least one sub-range to be tested of the command bit sequence.

In one exemplary embodiment, configuration information 304 comprises a bus number in order to determine which data bus or data buses 110 are to be tested. The configuration information 304 may furthermore comprise an address of slave unit 114, the response of which is to be changed on response channel 116.

Configuration information 304 furthermore comprises manipulation data and a manipulation mode. The manipulation data represent a portion of the response rule for providing the test response or for providing a sequence of test responses to be provided in succession. It is possible for one or multiple complete test responses to be stored in the manipulation data. It is likewise possible for individual bits to be changed of the response of slave unit 114 to be stored in the manipulation data. The manipulation mode also represents a portion of the response rule for providing the test response. The manipulation mode characterizes necessary boundary conditions for providing the test response.

In other words, FIG. 3 shows a device 100 for software tests on the basis of SPI manipulations in real time. Data bus 110 is in this instance an SPI bus 110. Device 100 may also be referred to as SPI manipulator 100. In SPI bus 110, master unit 112 is called master 112, while slave units 114 are called slaves 114. Up to four separate SPI buses 110 may be connected simultaneously to one device 100. As clock channel 302, SPI bus 110 has an SCLK or system clock. As command channel, SPI bus 110 has a MOSI or master out slave in. As response channel 116, SPI bus 110 has a MISO channel (which may also be called a master-in-slave-out data transmission channel). Address channel 300 in SPI bus 110 is formed by one SS channel (which may also be called slave select channel) per slave. In the exemplary embodiment shown, the SPI bus thus has an SS1 channel for the first slave 114 and an SS2 channel for the second slave 114. The SPI manipulator 100 is looped into the MISO channel. There is thus no direct connection between the MISO (channel) outputs of slaves 114 and the MISO (channel) input of master 112.

Via the MOSI channel, it is possible for example 120 to transmit different commands from master 112 to slaves 114. Slaves 114 monitor the MOSI channel continuously, but react only if they are addressed via the SS channel 300 that is assigned to them.

When a slave 114 is addressed by a command on the MOSI channel, a response to the command is provided directly via the MISO channel. The SPI manipulator 100 changes or falsifies this response in order to be able to analyze a reaction of master 112 to this adapted false response or test response. It is possible to map values in the test response in a bit-precise manner, which values are stored in master 112 as threshold values for an action.

The SPI number, the slave select line, the SPI trigger bits, the SPI trigger mask and the conditional control register (32 bits per interference unit) are stored as configuration information 304 in SPI bus 110. The SPI number defines which of the connected buses is tested. The slave select line defines which slave 114 is to be tested. The bit pattern of the command that is to be tested is stored in the SPI trigger bits. The number of the bits necessary to identify the command and the location within the bit sequence of the command are defined in the SPI trigger mask. The location may also be defined at multiple positions within the bit sequence.

Furthermore, the manipulation data and the manipulation mode are stored in configuration information 304.

SPI manipulator 100 is used to manipulate data bits on the SPI-MISO line or channel in real time. This makes it possible to test, in bit-precise fashion, software systems in which the communication between the microcontroller μC (SPI master) 112 and the ASICs (SPI slaves) 114 occurs via the SPI bus line. The approach provided here makes it possible to avoid a change in the peripheral settings of the control unit. Inmost cases, a bit-precise testing is not possible via the settings on the peripherals.

Following the same principle, it is also possible to manipulate the SPI-MOSI line, or both lines, if there are two instances of unit 124.

SPI manipulator 100 is used to manipulate data bits on the SPI-MISO line or channel in real time.

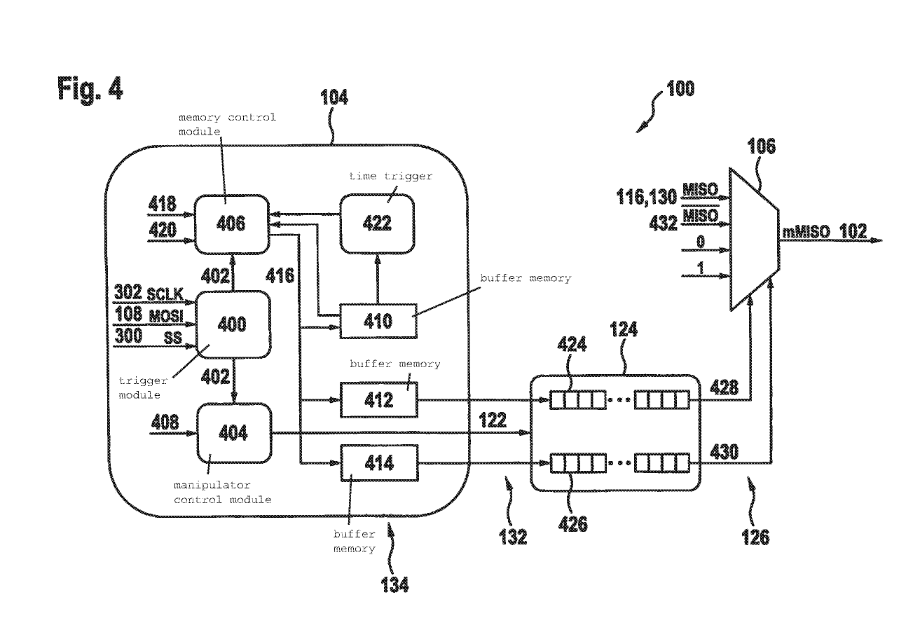

FIG. 4 shows a representation of a device 100 for providing a test response 102 according to one exemplary embodiment. Device 100 essentially corresponds to a device as is represented in FIG. 1. In this instance, only monitoring device 104 and output device 106 as well as short-term memory 124 are shown. Device 100 shown in FIG. 4 is in particular a component of the device in FIG. 3. Monitoring device 104 has different modules in this instance. A trigger module 400 monitors the bit sequence on command channel 108. The commands are 32 bits in length, for example. In order to detect the command, the first ten bits of the bit sequence are monitored. The remaining bits contain additional information, for example. The trigger module furthermore monitors address channel 300 and clock channel 302. A trigger signal 402 is provided if the slave unit defined in the configuration information is addressed on address channel 300 and if the bit sequence representing the command and defined in the configuration information is received via command channel 108. Trigger signal 402 is provided for a manipulator control module 404 and a memory control module 406.

Trigger information 122 for short-term memory 124 is output in manipulator control module 404 if trigger signal 402 is received and an additional condition 408 is fulfilled. It is possible, for example, to use one and the same command in different contexts on the data bus. Because of the additional condition 408, it is possible to provide test response 102 if the correct context obtains and to hold back test response 102 if the wrong context obtains. The additional condition 408 may be referred to as enable signal 408.

Buffer memories 410, 412, 414 are controlled via memory control module 406. Buffer memories 410, 412, 414 in this instance correspond to unit 134 for writing into short-term memory 124 in FIG. 1. Buffer memories 410, 412, 414 are operated here as FIFO memories, an item of information that is first read into one of buffer memories 410, 412, 414 is also first read out again. Buffer memories 410, 412, 414 are controlled via a read-out signal 416 by memory control module 406. Read-out signal 416 is provided by memory control module 406 when a global start signal 418 or an external start signal 420 has been read in and trigger signal 402 is received.

The manipulation mode in this instance is stored in first buffer memory 410. When reading out first buffer memory 410 in response to read-out signal 416, a time trigger 422 and/or memory control module 406 is activated.

The response rule 132 that is to be loaded next into short-term memory 124 is prestored in second buffer memory 412 and third buffer memory 414. The content of second buffer memory 412 and of third buffer memory 414 is shifted into short-term memory 124 in response to read-out signal 416. Since read-out signal 416 like trigger information 122 depends on trigger signal 402, buffer memory 124 is already emptied when buffer memories 412, 414 are read out. An item of control information 424 of the next response rule 132 is stored in second buffer memory 412. An item of data information 426 of the next response rule 132 is stored in third buffer memory 414. Control information 424 here represents a bit sequence of control bits 428 for controlling output device 106. Data information 426 here represents a bit sequence of data bits 430 for controlling output device 106.

Short-term memory 124 is in this instance a 32-bit shift register. Short-term memory 124 has a 32-bit control shift register for control information 424. The short-term memory has a 32-bit data shift register for data information 426.

Output device 106 is in this instance a four-bit-to-one-bit multiplexer 106. For each bit output as test response 102, multiplexer 106 is controlled by respectively one control bit 428 and one data bit 430. The response channel 116 with response 130 from the addressed slave unit, the inverted response channel 432 with the inverted response from the addressed slave unit, logical zero and logical one are applied to the four inputs of multiplexer 106.

If control bit 428 and data bit 430 are zero, the corresponding bit of response 130 is output as test response 102. If control bit 428 is zero and data bit 430 is one, then the corresponding bit of the inverted response is output as test response 102. If control bit 428 is one and data bit 430 is zero, then logical zero is output as test response 102. If control bit 428 and data bit 430 are one, then logical one is output as test response 102.

The basic idea of the SPI manipulator 100 is based one 4-bit-to-1-bit multiplexer 106, which is controlled by the most significant bit MSB from two shift registers 124. When the SPI pattern is detected, shift registers 124 are preloaded with the values from the FIFOs control and data 412, 414 and are shifted one bit onward with each SPI clock cycle. The manipulation of MISO line 116 or channel begins with the next bit after detection of the SPI pattern. The two shift registers 124 are erased with each new SPI command. This has the consequence that the MISO bits remain non-manipulated in the event of a non-detected SPI pattern.

An SPI manipulation module 100 detects an SPI command that is to be disturbed and controls the synchronous reading of the three FIFOs 410, 412, 414 as a function of one of the four selected modes. If multiple SPI commands are to be manipulated simultaneously, a corresponding number of SPI manipulation modules maybe used for this purpose.

Control FIFO 412 and data FIFO 414 have, for example, a width of 32 bits and a depth of 512 entries. Control FIFO 412 and data FIFO 414 contain the manipulation data for controlling the 4-bit-to-1-bit multiplexer 106.

The mode FIFO 410 has, for example, a width of 32 bits and a depth of 512 entries. Bit 31 to bit 28 contain the modes that determine under what conditions the next reading of the three FIFOs 410, 412, 414 occurs. Bit 27 to bit 0 contain the preload value for the timer. These bits are relevant only for the timer mode.

After each detected SPI pattern, the three FIFOs 410, 412, 414 are read in the SPI trigger mode. In the time trigger mode, FIFOs 410, 412, 414 are read when the 28-bit timer has elapsed. At the same time, a new timer value is loaded. An adjustable manipulation time is thereby achieved. In the global trigger mode, the reading of the FIFOs because of a defined event occurs simultaneously by all SPI manipulation modules. In the external trigger mode, the trigger for reading the FIFOs 410, 412, 414 occurs interactively from a PC, after previously, also from the PC, an entry was made in FIFOs 410, 412, 414. This makes it possible to simulate changes in the peripherals via “virtual peripherals”, without changing the real peripheral settings.

Depending on the active trigger mode and the effected trigger, FIFO control module 406 decides when the three FIFOs 410, 412, 414 are read anew. With each reading of the mode FIFO 410, it is also possible to switch mode.

SPI trigger module 400 is used to detect an arbitrary pattern on the SPI. This occurs with the aid of two 32-bit registers. The mask register contains a “1” for the relevant bits. The pattern register contains the bits to be tested vis-a-vis the MOSI line 108. Both registers are shifted towards the left in SPI clock cycle 302 and reloaded with “0”. As soon as all bits in the mask register have the value zero, the pattern counts as detected and a trigger 402 is sent to the modules FIFO control 406 and manipulator control 404.

Following the expiration of a pS timer, time trigger module 422 sends a trigger to the FIFO control module 406. This has the effect that FIFOs 410, 412, 414 are read anew and thus that also a new timer value is preloaded.

Manipulator control module 404 determines when the interference patterns 132 applied on the outputs of FIFOs 412, 414 are copied into the two shift registers 124. The copying only occurs, however, if conditional control 408 is logical “1”. The conditional control condition may be used when the detection of an SPI pattern on MOSI line 108 is not clear or if another condition must be fulfilled in the system. For this purpose, an additional module must be created, which creates the condition to which one or multiple interference units can react when they are configured accordingly.

If an exemplary embodiment comprises an “and/or” linkage between a first feature and a second feature, then this is to be read in such a way that the exemplary embodiment according to one specific embodiment has both the first features as well as the second feature and according to another specific embodiment has either only the first feature or only the second feature.

1-11. (canceled)

12. A method for providing a test response for testing a function of a master unit of a synchronous serial data bus, the method comprising:
monitoring a command bit sequence on a command channel of the data bus to detect a predetermined command from the master unit; and
providing the test response on a response channel of the data bus in response to a detected predetermined command, a response bit sequence of the test response being provided by using a response rule predefined in a short-term memory.

13. The method as recited in claim 12, further comprising:
writing a further response rule into the short-term memory, after the command is detected, the further response rule being written by using a test rule.

14. The method as recited in claim 12, wherein in which in the providing step, the test response is provided by using a response on the response channel resulting from the command, the response being read in and at least one bit of the response being changed by using the response rule in order to obtain the test response.

15. The method as recited in claim 12, wherein in monitoring step, at least one address channel of the data bus is monitored, the command being detected if on the address channel a predetermined slave unit is addressed that is connected to the data bus and that is hierarchically subordinate to the master unit.

16. The method as recited in claim 12, wherein in the monitoring step, the command bit sequence is monitored by using a predefined command pattern in order to detect the command.

17. The method as recited in claim 12, wherein in the monitoring step, at least one predefined sub-range of the command bit sequence is monitored in order to detect the command.

18. The method as recited in claim 17, wherein in the monitoring step, a first sub-range and at least one second sub-range of the command bit sequence are monitored in order to detect the command.

19. The method as recited in claim 12, wherein in the providing step, the test response is provided in response to an enable signal.

20. The method as recited in claim 12, further comprising:
predefining, in response to a start signal, the response rule in the short-term memory, the predefining step being performed before the providing step.

21. A device for providing a test response for testing a function of a master unit of a synchronous serial data bus, the device comprising:
a monitoring device designed to monitor a command bit sequence on a command channel of the data bus to detect a predetermined command from the master unit; and
an output device developed to provide a response bit sequence of the test response on a response channel of the data bus in response to a detected predetermined command by using a response rule predefined in a short-term memory, the output device being looped into the response channel.

22. A machine-readable storage medium on which is stored a computer program for providing a test response for testing a function of a master unit of a synchronous serial data bus, the computer program, when executed by a computer, causing the computer to perform:
monitoring a command bit sequence on a command channel of the data bus to detect a predetermined command from the master unit; and
providing the test response on a response channel of the data bus in response to a detected predetermined command, a response bit sequence of the test response being provided by using a response rule predefined in a short-term memory.
